(19) United States
(12) Patent Application Publication
(10) Pub. No.: US 2007/0011708 A1
(43) Pub. Date: Jan. 11, 2007

(54) Microwave AV radio transmission system

(76) Inventor: Ming-Fang Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/172,847

(22) Filed: Jul. 5, 2005

(51) Int. Cl. H04N 7/16; H04N 7/173; H04N 7/18

(52) U.S. Cl. 725/81; 725/80; 725/133; 725/141; 725/151

(57) ABSTRACT

A microwave AV (audio and video) radio transmission system for reduction in cabled transmission, upgraded signal quality and quantity, lowered production cost, and neater appearance includes a transmitter and a receiver. The transmitter is connected to a socket of an AV source system. The receiver is connected to a socket of a receiving system. Each of the transmitter and the receiver comprises a plug to be directly plugged into the sockets of the AV source system and the receiving system, respectively. No AV cable is required for the connection.

### BACKGROUND OF THE INVENTION

(a) Field of the Invention

The present invention relates to a microwave AV (audio and video) radio transmission system, and more particularly, to one that is directly plugged into an AV source system and a receiving system without connection of AV cables.

(b) Description of the Prior Art

Whereas TV set is one of the most popular consumer electronic products for home entertainment and access to information and more AV systems including VDC, DVD, VCR, satellite receiver, and Hi-Fi are available, it is not unusual that a family may have several TV sets in different rooms to satisfy diversified viewing needs of the individual family member. To avoid the chaos caused by the cables connecting all those TV sets, the home microwave AV radio transmission becomes popular.

As illustrated in FIG. 7 of the accompanying drawings, a conventional microwave AV radio transmission system comprises a transmitter (A) connected to an AV source system (D) with a cable (C) and a receiver (B) connected to a receiving system (F), i.e., a TV set, with another cable (E) in RC mode by means of a remote controller (G). In use, the transmitter (A) or the receiver (B) is placed either on the AV source system (D) or the receiving system (F) while leaving a bunch of cables (C) and (E) behind the AV source system (D) and the receiving system (F) to cause a disaster to the neatness of the room. Furthermore, the use of cable not only increases the cost but also is blamed for deteriorating signal attenuation.

### SUMMARY OF THE INVENTION

The primary purpose of the present invention is to provide a microwave AV radio transmission system that has its transmitter or receiver to directly plug into an AV source system and a monitor to offer a totally “wireless” solution to minimize cabled transmission, upgrade signal quality and quantity, reduce production cost, and help maintain neat appearance since no cable is required.

To achieve the purpose, the present invention comprises a transmitter connected to a socket of an AV source system and a receiver connected to a socket of a receiving system. Each of the transmitter and the receiver is provided with a plug to be directly plugged into its corresponding sockets of the AV source system and the receiving system, respectively, without the use of an AV cable.

The transmitter (receiver) of the present invention includes a casing, a circuit board, a transmission (receiving) modulation module, and a plug. Wherein, the circuit board contained in the casing is connected to the transmission (receiving) modulation module and the plug with the plug exposed out of one side of the casing. The circuit board is further connected to a remote control receiving (transmission) antenna.

Furthermore, the transmitter (the receiver) of the present invention further comprises a socket.

### BRIEF DESCRIPTION OF THE DRAWINGS

FIG. 1 is an exploded view of the present invention.

FIG. 2 is a perspective view of the present invention.

FIG. 3 is a schematic view showing plug-in of a preferred embodiment of the present invention.

FIG. 4 is a schematic view showing the operation of the preferred embodiment of the present invention.

FIG. 5 is a perspective view of another preferred embodiment of the present invention.

FIG. 6 is a perspective view of another preferred embodiment yet of the present invention.

FIG. 7 is a schematic view showing plug-in and operation status of a prior art.

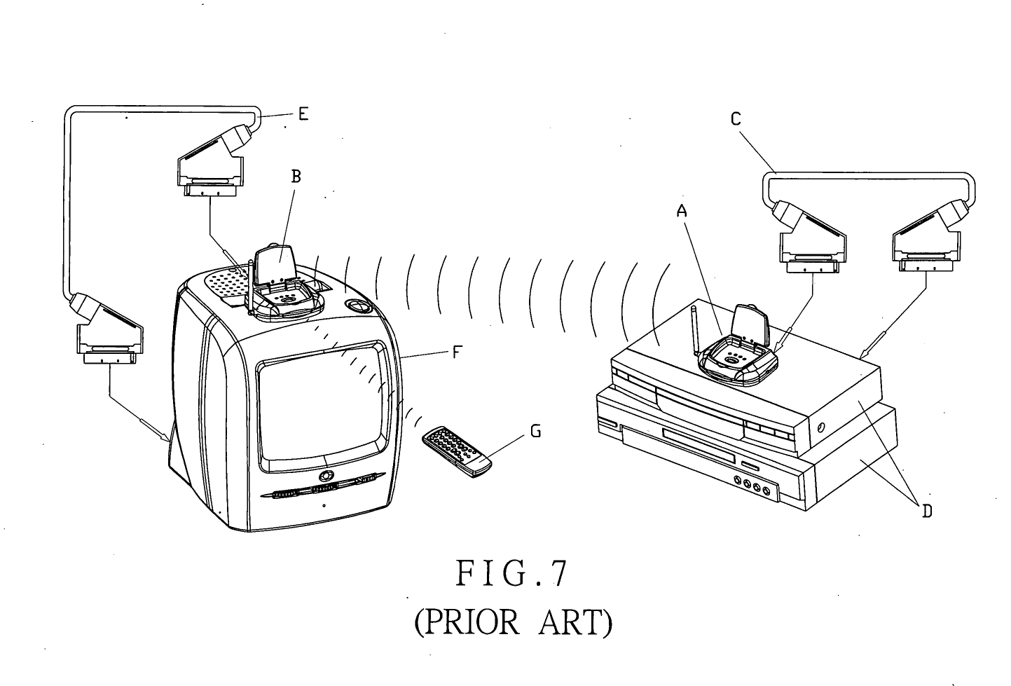

### DETAILED DESCRIPTION OF THE PREFERRED EMBODIMENTS

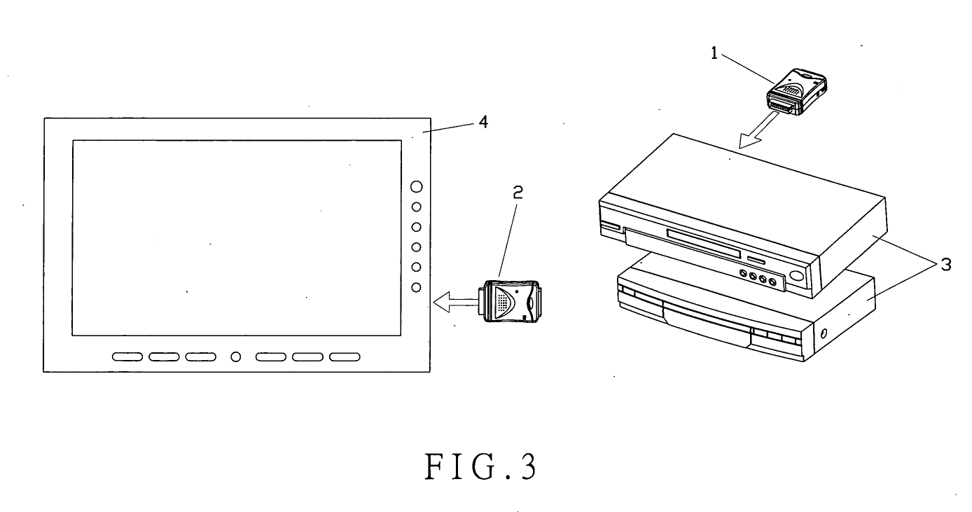

Referring to FIG. 3, the present invention comprises a transmitter (1) and a receiver (2). The transmitter (1) is connected to a socket (a prior art, not illustrated) of an AV source system (3), and the receiver (2) is connected to a socket (a prior art, not illustrated) of a receiving system (3).

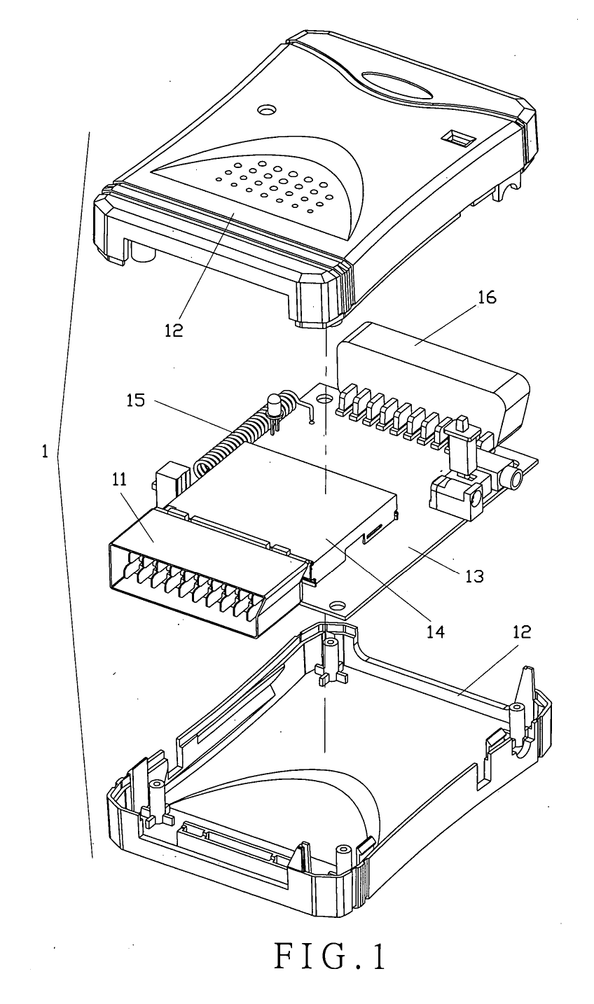

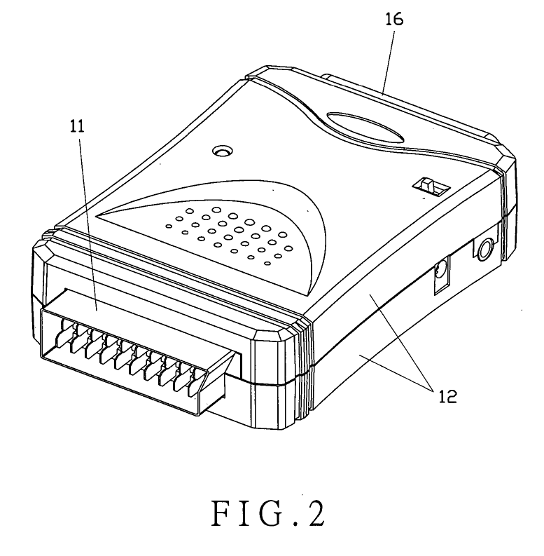

As illustrated in FIGS. 1 and 2, the transmitter (1) includes a plug (11) to be directly plugged into the AV source system (3) (or into the receiving system (4) in case of the receiver (2)). Whereas components of the receiver (2) are similar to those of the transmitter (1), only those components of the transmitter (1) are described. The transmitter (1) further includes a casing (12), a circuit board (13), a transmission modulation module (14) (or a receiving modulation module in case of the receiver (2)). The circuit board (13) contained in the casing (12) is connected to the transmission modulation module (14) and the plug (11), and the plug (11) is exposed out of one side of the casing (12) to facilitate the direct plug-in to connect to the AV source system (3) (or to the receiving system (4)). The circuit board (13) is further connected to a remote control receiving antenna (15) (or to a remote control transmission antenna in case of the circuit board of the receiver (2)), and infrared remote control components. The transmitter (1) further comprises a socket (16) for extended additional interface.

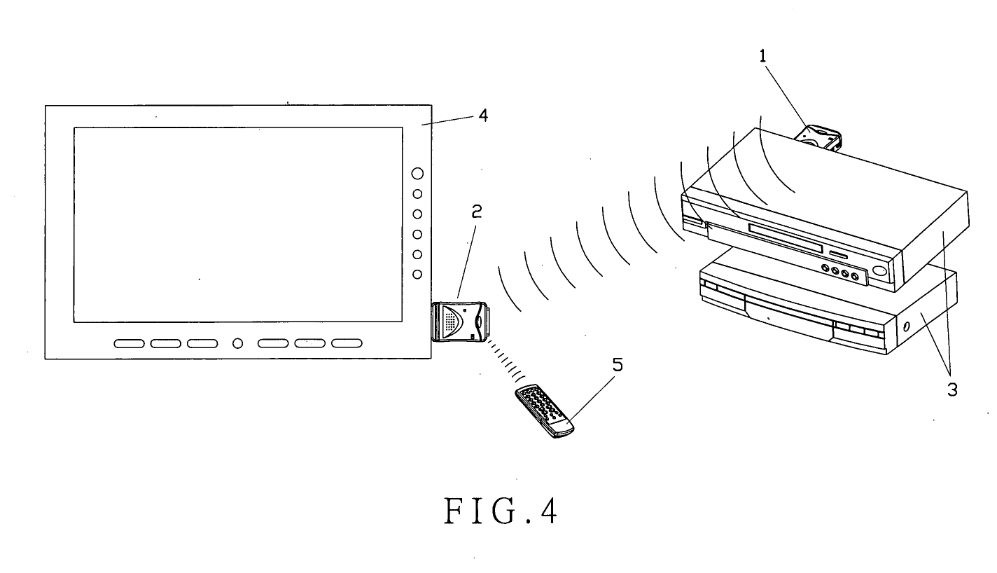

As illustrated in FIG. 3, the transmitter (1) is connected to the AV source system (3); and the receiver (2), to the receiving system (4). Both the AV source system (3) and the receiving system (4) may be placed in two different rooms and long distance control is achieved by means of a remote controller (5) as illustrated in FIG. 4.

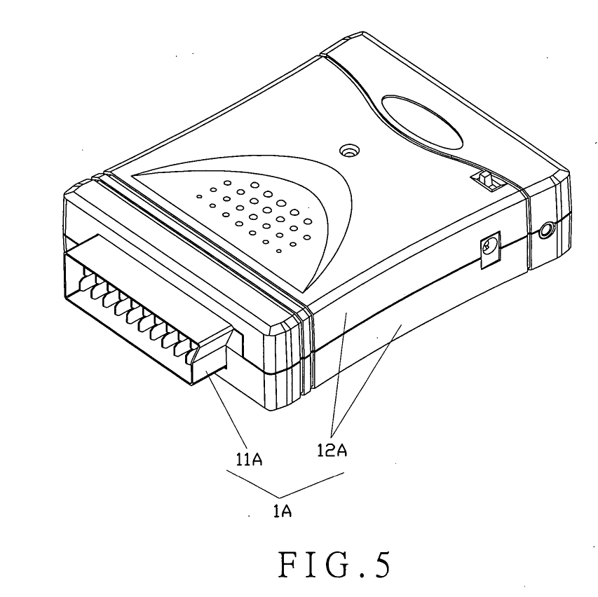

Now referring to FIG. 5 for another preferred embodiment of the present invention, only a plug (11A) with the omission of a socket is disposed on a casing (12A) of a transmitter (1A) (the same goes to its matching receiver).

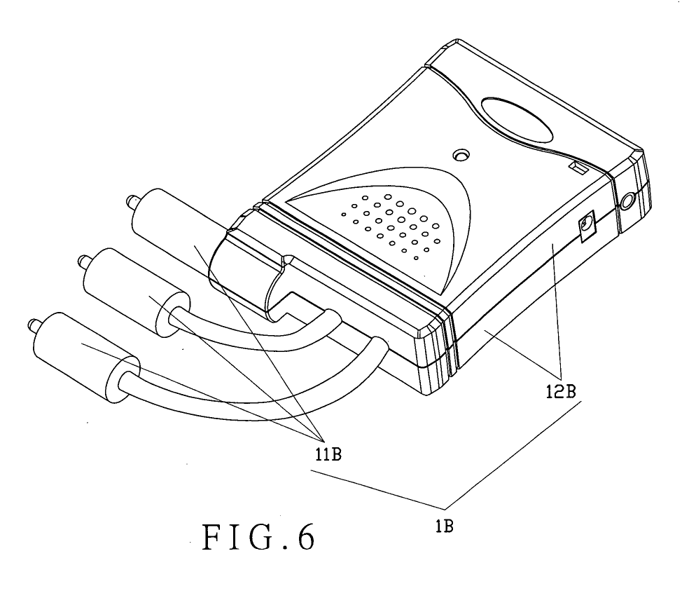

In another preferred embodiment yet of the present invention as illustrated in FIG. 6, a plug (11B) provided with conventional AV terminals is provided to a casing (12B) of a transmitter (1B) (the same goes to its matching receiver).

I claim:

1. A microwave AV (audio and video) radio transmission system comprising a transmitter and a receiver; said transmitter being connected to a socket of an AV source system and said receiver being connected to a socket of a receiving system, and characterized in that:
each of said transmitter and said receiver comprising a plug to be directly plugged into the sockets of said AV source system and said receiving system, respectively.

2. The microwave AV radio transmission system of claim 1, wherein said transmitter further comprises a casing, a circuit board, and a transmission modulation module; said circuit board contained in said casing being connected to said transmission modulation module and said plug; and said plug being exposed out of one side of said casing.

3. The microwave AV radio transmission system of claim 2, wherein said circuit board of said transmitter is further connected to a remote control receiving antenna.

4. The microwave AV radio transmission system of claim 1, wherein said receiver further comprises a casing, a circuit board, and a receiving modulation module; said circuit board contained in said casing being connected to said receiving modulation module and said plug; and said plug being exposed out of one side of said casing.

5. The microwave AV radio transmission system of claim 4, wherein said circuit board of said receiver is further connected to a remote control transmission antenna.

6. The microwave AV radio transmission system of claim 1, wherein each of said transmitter and said receiver further comprises a socket.
